(19) United States
(12) Patent Application Publication
(10) Pub. No.: US 2011/0060686 A1
(43) Pub. Date: Mar. 10, 2011

(54) System and Method for Communicating Check Information to a Financial Institution

(76) Inventor: Kenneth Gay, Batavia, IL (US)

(21) Appl. No.: 12/557,364

(22) Filed: Sep. 10, 2009

(51) Int. Cl. G06Q 40/00; G06F 15/16; G06K 9/00; H04N 1/40

(52) U.S. Cl. 705/44; 705/35; 705/45; 709/204; 382/138; 358/470

(57) ABSTRACT

A system for communicating check information to a financial institution is provided. The system includes but is not limited to a check reader, a centralized computer, and a financial institution computer. The check reader retrieves check information from a drawn check. The check information includes an amount of money, a routing number, and an account number. The centralized computer is in communication with the check reader. The centralized computer converts the check information into debit card data for transmission over a debit card network. The financial institution computer is in communication with the centralized computer via the debit card network. The debit card data is transmitted to the financial institution over the debit card network.

### FIELD OF THE INVENTION

The present invention relates generally to a system and method for communicating information to a financial institution. In particular, the invention relates to a system and method for communicating check information to a financial institution.

### BACKGROUND

In order to make a payment, often times a consumer receives a check drawn for an amount of money to be paid to a payee for a service or good. Many times payees to do not have a bank account in which they can deposit the drawn check and have to use a third party, such as a retail check cashing facility, to assist the payee in cashing the drawn check. However, in cashing the drawn check, the third party often verifies that the maker's demand account, from which the amount of money is to be withdrawn, has an available balance which exceeds that of the amount of money the drawn check is drafted for.

Once it is confirmed that the available balance exceeds that of the amount of money the drawn check is drafted for, the third party then often times makes an image of the check and sends it to their depository, a local, centralized bank, which processes the check and sends the processed check to the Federal Reserve for further processing and payment via the makers bank. This process may take several days before the drawn check is finally presented to the maker's bank, and the maker's demand account is debited the amount of money the drawn check is drafted for. In the several days, however, money may be withdrawn from the maker's demand account and the available balance may not exceed the amount of money the drawn check is drafted for. In this instance, the drawn check presented to the maker's bank may be denied by the maker's bank, no money can be withdrawn from the maker's demand account, and a denied check notice is sent to the maker, the third party, and/or the payee. The third party suffers in that it often times pays the amount of money minus a transaction fee immediately to the payee upon receipt of the drawn check from the payee. In this instance, the third party would lose the amount of money minus a transaction fee. Additionally, the payee may also be required to pay back the amount of money to the third party. Either way, the payee and the third party may both suffer from not being able to present the drawn check in real-time to the maker's bank for withdrawal of funds within the maker's demand account.

As a result, it would be desirable to provide a system and method for communicating check information to a financial institution which can reduce the amount of drawn checks which are denied when presented to financial institutions. It would also be desirable to provide a system and method for communicating check information in real-time to a financial institution, so that an amount of money may be segregated for withdrawal in real-time from a maker's demand account.

### SUMMARY

In one aspect, a method for communicating check information to a financial institution is provided. The method includes but is not limited to retrieving check information from a drawn check. The check information includes but is not limited to an amount of money, a routing number, and an account number. The method also includes but is not limited to transmitting the check information to a conversion device and converting the check information into debit card data. The method also includes but is not limited to transmitting the debit card data to a financial institution having a demand account. The financial institution is assigned the routing number of the drawn check. The demand account is assigned the account number of the drawn check.

In another aspect, a system for communicating check information to a financial institution is provided. The system includes but is not limited to a check reader, a centralized computer, and a financial institution computer. The check reader retrieves check information from a drawn check. The check information includes an amount of money, a routing number, and an account number. The centralized computer is in communication with the check reader. The centralized computer converts the check information into debit card data for transmission over a debit card network. The financial institution computer is in communication with the centralized computer via the debit card network. The debit card data is transmitted to the financial institution over the debit card network.

In another aspect, a signal bearing medium storing instructions of a computer program which when executed by a computer results in performance of steps is provided. The steps includes but are not limited to receiving check information from a drawn check, converting the check information into debit card data, and transmitting the debit card data to a demand account at a financial institution. The check information includes an amount of money, a routing number, and an account number. The debit card data includes the amount of money, the routing number, and the account number, and a debit card network name. The financial institution is assigned the routing number of the drawn check. The demand account is assigned the account number of the drawn check.

The scope of the present invention is defined solely by the appended claims and is not affected by the statements within this summary.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 depicts a block schematic diagram of an exemplary computing system, in accordance with one embodiment of the present invention.

FIG. 2 depicts a schematic representation of a system for communicating check information to a financial institution, in accordance with one embodiment of the present invention.

FIG. 3 depicts a schematic representation of check information being converted into debit card information.

FIG. 4 depicts a flowchart illustration of methods, apparatus (systems) and computer program products, in accordance with one embodiment of the present invention.

FIG. 5 depicts a flowchart illustration of methods, apparatus (systems) and computer program products, in accordance with one embodiment of the present invention.

### DETAILED DESCRIPTION

The present invention makes use of the discovery that by converting check information retrieved from a check into debit card data, and then transmitting the debit card data containing the check information over a debit card network, money held in a check maker's demand account can immediately tagged for withdrawal, reducing the likelihood that the check will bounce.

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those skilled in the art will appreciate that some of the acts and operations described hereinafter can also be implemented in hardware, software, and/or firmware and/or some combination thereof.

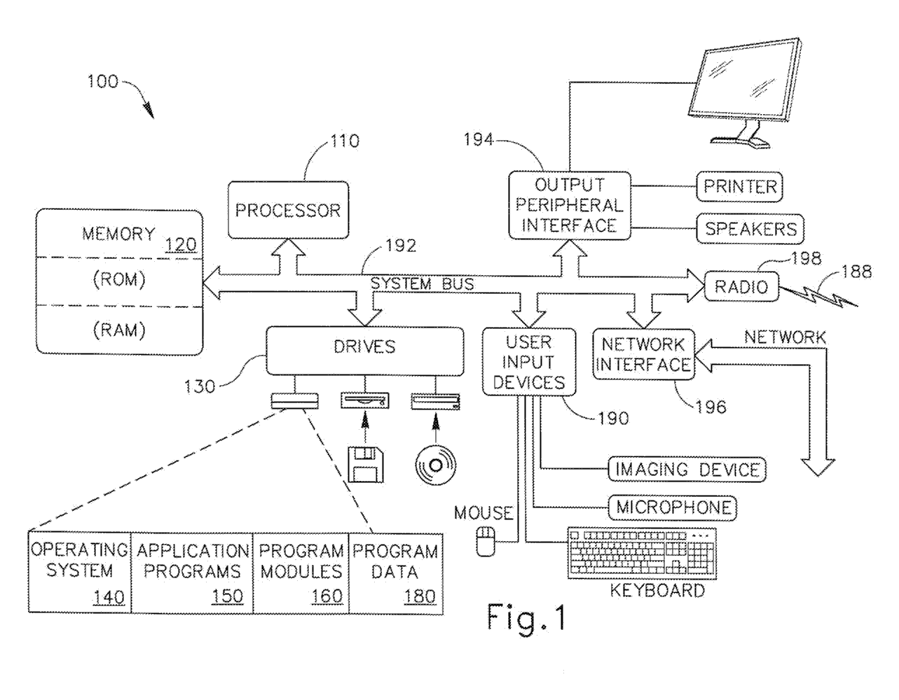

With reference to FIG. 1, depicted is an exemplary computing system for implementing embodiments. FIG. 1 includes a computer 100, which could be any one of an imaging recognition computer 218, a centralized computer 242, or a financial institution computer 276. Computer 100 may be a mobile device, wherein at least some or all of its components are formed together in a single device which can move from one location to another, such as a laptop computer, a mobile telephone, a portable electronic device, or a personal digital assistant (PDA). Computer 100 may be a stationary or non-mobile device which is not moved around, such as a desktop computer or server. Computer 100 may also be incorporated within a multitude of devices, such as a check reader 210 or a conversion device 240. The computer 100 includes a processor 110, memory 120 and one or more drives 130. The drives 130 and their associated computer storage media provide storage of computer readable instructions, data structures, program modules and other data for the computer 100. Drives 130 can include an operating system 140, application programs 150, program modules 160, and program data 180. Computer 100 further includes input devices 190 through which data may enter the computer 100, either automatically or by a user who enters commands and data. Input devices 190 can include an electronic digitizer, a microphone, a camera, a video camera, an imaging device such as an optical scanner or camera, a keyboard, and a pointing device, commonly referred to as a mouse, trackball or touch pad. Other input devices may include a joystick, game pad, satellite dish, scanner, and the like.

These and other input devices 190 can be connected to processor 110 through a user input interface that is coupled to a system bus 192, but may be connected by other interface and bus structures, such as a parallel port, game port or a universal serial bus (USB). Computers such as computer 100 may also include other peripheral output devices such as speakers and/or display devices, which may be connected through an output peripheral interface 194 and the like.

In one embodiment, computer 100 includes a radio 198 for wirelessly transmitting and receiving data for the computer 100 with the aid of an antenna. Radio 198 may wirelessly transmit and receive data using any present wireless standard such as WiMAX™, 802.11a/b/g/n, Bluetooth™, 2G, 2.5G, 3G, and 4G. Additionally, radio 198 may receive positioning signals 188, such as global positioning satellite (GPS) signals from a global positioning satellite or cellular signals for determining its position via triangulation. By using the positioning signals 188, the radio 198 is able to determine its location.

Computer 100 may operate in a networked environment using logical connections to one or more remote computers, such as a centralized computer. The centralized computer may be a personal computer, a server, a router, a network PC, a peer device or other common network node, and may include many if not all of the elements described above relative to computer 100. Networking environments are commonplace in offices, enterprise-wide computer networks, intranets and the Internet. For example, in the subject matter of the present application, computer 100 may comprise the source machine from which data is being migrated, and the centralized computer may comprise the destination machine. Note, however, that source and destination machines need not be connected by a network or any other means, but instead, data may be migrated via any media capable of being written by the source platform and read by the destination platform or platforms. When used in a LAN or WLAN networking environment, computer 100 is connected to the LAN through a network interface 196 or an adapter. When used in a WAN networking environment, computer 100 typically includes a modem or other means for establishing communications over the WAN to environments such as the Internet. It will be appreciated that other means of establishing a communications link between the computers may be used.

According to one embodiment, computer 100 is connected in a networking environment such that processor 1 10 can process incoming and outgoing data, such as data which contains imaging and check information, and the like. The incoming and outgoing data can be to and/or from any device, such as from another data source, such as imaging recognition computer 218, centralized computer 242, or financial institution computer 276.

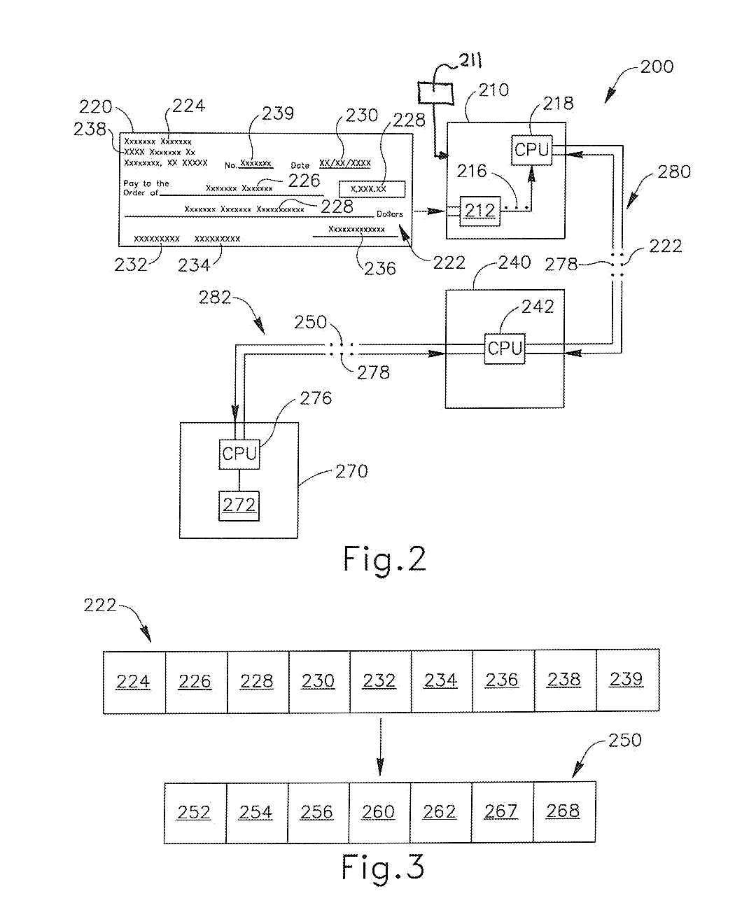

Referring to FIG. 2, illustrated is an exemplary representation of a system 200 for communicating check information 222 to a financial institution 270. The system 200 includes but is not limited to a check reader 210 connected with a conversion device 240 via a communications network 280, and a financial institution computer 276 connected with the conversion device 240 via a debit card network 282. The conversion device 240 converts check information 222 to debit card data 250 and sends debit card data 250 to the financial institution 270 and receives confirmation data 278 from the financial institution 270 via a debit card network 282.

Networks 280 and 282 can be, for example, a cellular network, (perhaps having a land line to one of the devices), a non-cellular wireless network, a wired network, or combinations thereof. Preferably, check reader 210 communicates with conversion device 240 via communications network 280 and conversion device 240 communicates with the financial institution 270, and specifically, financial institution computer 276, via debit card network 282. Communications network 280 transmits and receives data, such as check information 222 and confirmation data 278, between check reader 210 and conversion device 240. Debit card network 282 transmits and receives data, such as debit card data and confirmation data, between conversion device 240 and financial institution 270, and specifically, financial institution computer 276.

Network controllers can optionally be disposed within or connected with check reader 210, conversion device 240, and financial institution computer 276 in order to allow for communication over the networks 280, 282. Network controllers may be located at a base station, a service center, or any other location on networks 280, 282. Networks 280, 282 may include any type of networks which are capable of sending and receiving communication signals, including signals for financial information, images, and data such as confirmation data and debit card data.

Networks 280, 282 may include a data network, such as the Internet, an intranet, a local area network (LAN), a wide area network (WAN), a cable network, and other like systems that are capable of transmitting multimedia video, streaming video, audio and the like. Networks 280, 282 may also include a telecommunications network, such as a local telephone network, long distance telephone network, cellular telephone network, satellite communications network, cable television network and other like communications systems that interact with computers to enable set-top boxes or other audio/visual controllers to communicate media and multimedia signals. Networks 280, 282 may include more than one network and may include a plurality of different types of networks. Thus, networks 280, 282 may include a plurality of data networks, a plurality of telecommunications networks, cable systems, satellite systems and/or a combination of data and telecommunications networks and other like communication systems. In one embodiment, networks 280, 282 may include an email network or a Switched Multi-megabit Data Service (SMDS) network, with or without the SMDS Interface Protocol (SIP), using data packets for the delivery of data.

Note that while only one check reader 210 is shown, the system 200 is designed for communications among any number of check readers 210, some of which are mobile and, if desired some of which may be fixed in location. Also note that check reader 210 can be substituted by any device or combination of devices which can retrieve check information 222 from a drawn check 220, such as an optical scanner, a camera, a bar code reader, a magnetic strip reader, or an RFID reader, in combination with a laptop computer, a tablet computer, a personal digital assistant, a mobile phone, a desktop computer, a server, and/or any other device that is capable of analyzing, sending and receiving data.

Check reader 210 retrieves check information 222 from a drawn check 220. The check reader 210 includes any device or combination of devices which can retrieve check information 222 from a drawn check 220, and preferably transmit the check information 222 to the conversion device 240. Drawn check 220 is any negotiable instrument issued by a maker to a payee, and includes things such as an order check, a bearer check, a counter check, a negotiable order of withdrawal, a share draft, an a payroll warrant. Check information 222 is any information on either a front or back surface of the drawn check 220, and includes information such as a the maker's name 224, the payee's name 226, an amount of money 228 which is authorized to be drawn from the maker's demand account 272 at the maker's financial institution 270, a date of issue 230 which is the date that the drawn check 220 is drafted, a routing number 232 which identifies the maker's financial institution 270, an account number 234 which identifies the maker's demand account 272, the maker's signature 236 which verifies the maker's identity, and the maker's personal information 238 which may include the maker's address, phone number, and social security number, and a check number 239 which identifies the drawn check 220.

Preferably, the routing number 232 is a nine-digit number in which the first 4 digits identifies the U.S. Federal Reserve Bank's check-processing center, the fifth through eight digits identify the financial institution 270 which is served by that check-processing center, and the ninth digit is a verification check digit computed using a complex algorithm of the previous 8 digits. The routing number 232 is preferably followed by the account number 234 which identifies the maker's demand account 272, and the check number 239 which identifies the drawn check 220.

The check information 222 may be retrieved from the drawn check 220 by the check reader 210 in one of a variety of different ways. In one embodiment, the check reader 210 includes an input device 211 through which check information 222 may enter the check reader 210, either automatically or by a user who enters commands and data. The input device 211 includes things such as a keyboard, mouse, or touch screen. In this embodiment, a user inputs the check information 222 manually into the check reader 210 via the input device 211, such as a keyboard, mouse, or touch screen.

In one embodiment, the check reader 210 includes or is connected with an imaging device 212 which is in communication with imaging recognition computer 218. The imaging device 212 may be any device which can capture an image of the drawn check 220, such as an optical scanner or camera. In this embodiment, the drawn check 220 is placed near or inserted into the imaging device 212, and an image of the drawn check 220 is made using an imaging device 212. Once the image of the drawn check 220 is captured, the image is digitized and converted into image data 216 which is then communicated to imaging recognition computer 218. The check reader 210 may have both the input device 211 and the imaging device 212, so that the check information 222 is retrieved by the check reader 210 using a combination of user input at the input device 211 and image capture made by the imaging device 212.

Check reader 210 may be a stationary device which is not designed to be carried around with a user or check reader 210 may be a portable device, such as a mobile phone with a camera, which can be carried around with the user.

Imaging recognition computer 218 may retrieve check information 222 from the image data 216, using, for example, optical character recognition. In one embodiment, the check reader 210 includes an identifying scanner, such as a bar code scanner, a magnetic reader, or an RFID reader, and the drawn check 220 includes a unique identifier, such as a bar code, a magnetic strip, or an embedded RFID chip. The identifying scanner scans or reads the unique identifier and then retrieves check information 222 from the drawn check 220. In one embodiment, the check reader 210 is a Smart Teller II device manufactured by Technology Effectiveness Solutions of Ponte Vedra Beach, Fla. Preferably, upon retrieving the check information 222 from the drawn check 220, the check reader 210 places a mark on the check which indicates that the drawn check 220 has been processed.

Upon retrieving the check information 222 from the drawn check 220, the check information 222 is transmitted to conversion device 240 via communications network 280. Referring to FIGS. 2 and 3, conversion device 240 converts check information 222 received from 210 via network 280 to debit card data 250, sends the debit card data 250 to the financial institution 270, and receives confirmation data 278 from the financial institution 270 via debit card network 282. The conversion device includes a centralized computer 242 which receives the check information 222 and converts the check information 222 into debit card data, which is in a format that is acceptable for transmission over debit card network 282.

Preferably, the debit card data includes a maker's name 252, a payee's name 254, an amount of money 256, a date of issue 258, a routing number 260, an account number 262, security information 264, a maker's personal information 266, a check number 267, and debit card network information 268. The maker's name 252 and the payee's name 254 are derived from the maker's name 224 and the payee's name 226 from the check information 222, respectively. The amount of money 256 and the date of issue 258 are derived from the amount of money 228 and the date of issue 230 from the check information 222, respectively. The routing number 260, the account number 262, and the check number 267 are derived from the routing number 232, the account number 234, and the check number 239 from the check information 222, respectively. The security information 264 is any information which can validate that the check is authentic, and may be derived from the maker's signature 236. The maker's personal information 266 includes things such as the maker's address and social security number, and may be derived from the maker's personal information 238. The debit card network information 268 is added by the conversion device 240, and specifically the centralized computer 242, and identifies the type of debit card network being used to send and receive information between the conversion device 240 and the financial institution 270. For example, if the debit card network 282 was through the PLUS™ or INTERLINK™ networks, then the debit card network information 268 would indicate such.

In one embodiment, the debit card data 250 includes the payee's name 254, the amount of money 256, the routing number 260, the account number 262, the check number 267, and the debit card network information 268.

In one embodiment, the conversion device 240 is directly connected with the check reader 210. In one embodiment, the check reader 210 and the conversion device 240 are formed as one unit. In one embodiment, the check reader 210 includes the conversion device 240. In this embodiment, preferably, the centralized computer 242 and the imaging recognition computer 218 are one computer.

Once the conversion device 240 converts the check information 222 into debit card data 250, the conversion device 240 then transmits the debit card data 250 to the financial institution 270 over the debit card network 282. Financial institution 270 is any institution that provides financial services for its clients or members. Financial institution 270 includes any bank, savings and loan, credit union, government institution, or the like. Financial institution 270 includes the maker's demand account 272 from which the amount of money 228 is to be withdrawn.

The financial institution 270 includes financial institution computer 276 which is in communication with the centralized computer 242 via the debit card network 282. The financial institution computer 276 controls the exchange of money into and out of the demand account 272. The demand account 272 is assigned the account number 234 on the drawn check 220. The demand account 272 has a total balance 273 which indicates the total amount of money at any time within the demand account 272, and an available balance 272 which indicates the amount of money at any time within the demand account 272 available for withdrawal. Upon receiving the debit card data 250, the financial institution computer 276 queries the demand account 272 to determine the available balance 272.

Upon receipt of the debit card data 250 and upon determination that sufficient funds exist in the demand account 272, the demand account 272 is debited by the financial institution computer 276. More specifically, if the available balance 272 is greater than the amount of money 228, then an amount of money equal to the amount of money 228 is debited or removed from the available balance 272 in real-time and flagged for withdrawal from the demand account 272 at a later date. Additionally, a sufficient funds notice is transmitted in real-time to a user within confirmation data 278 transmitted via the debit card network 282. The user is any person who is using system 200, and may include the maker, the payee, a third party who is assisting either the maker or the payee, or any beneficiary of the drawn check 220. As used herein, the term “in real-time” is preferably less than 12 hours, and more preferably, less than 6 hours, and more preferably less than one hour, and more preferably less than 30 minutes, and more preferably less than ten minutes, and most preferably less than five minutes.

Upon receipt of the debit card data 250 and upon determination that sufficient funds do not exist in the demand account 272, an insufficient funds notice is transmitted back to the user, preferably through the centralized computer 242. More specifically, if the available balance 272 is not greater than the amount of money 228, then no money is removed from the available balance 272 and an insufficient funds notice is issued and transmitted in real-time to a user within confirmation data 278 via the debit card network 282.

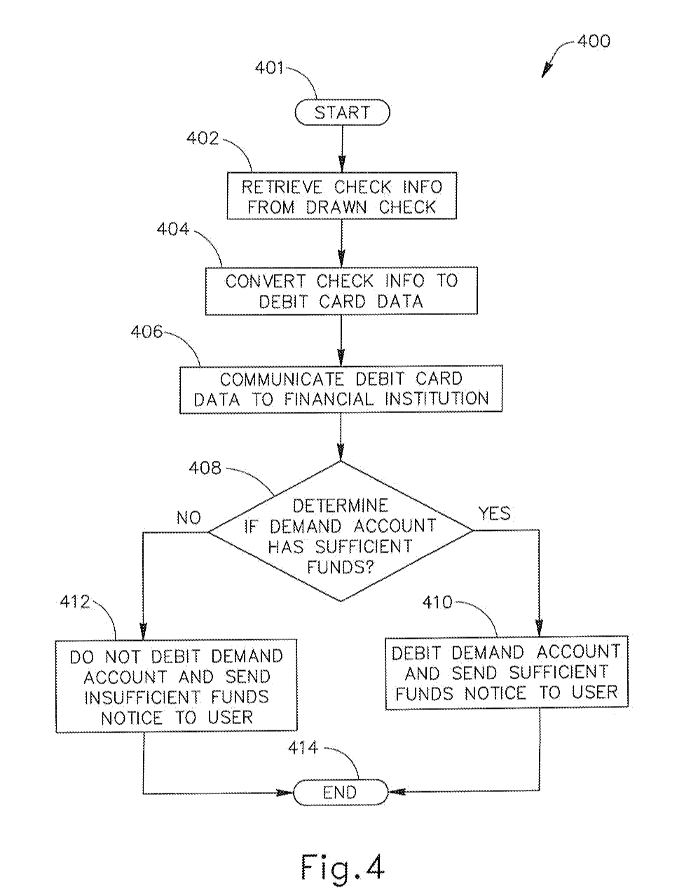

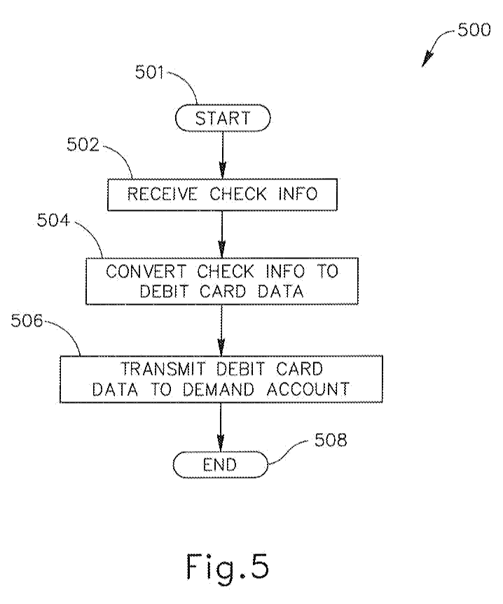

Referring to FIG. 4 a method 400 for communicating check information 222 to financial institution 270 is shown. The method 400 is initiated at block 401 when a user presents a drawn check 220 to the check reader 210. Then, at block 402, the check reader 210 retrieves check information 222 from the drawn check 220. The check information 222 is communicated to conversion device 240, whereupon at block 404 the conversion device 240 converts the check information 222 into debit card data 250. At block 206, the debit card data 250 is then communicated to the financial institution 270, and preferably, to financial institution computer 276. At block 408, a decision step is initiated whereupon it is determined whether or not the demand account 272 has sufficient funds. More specifically, at block 408, it is determined whether or not the amount of money 228 on the drawn check 220 is greater than or less than the available balance 274 of the demand account 272. Preferably, the decision step 408 is made by financial institution computer 276.

If it is determined that the demand account 272 has sufficient funds, then the method 400 moves to block 410, and the demand account 272 is debited the amount of money 228 and a sufficient funds notice is communicated to a user. If it is determined that the demand account 272 does not have sufficient funds, then the method 400 moves to block 412, and the demand account 272 is not debited the amount of money 228 and an insufficient funds notice is communicated to a user. Upon moving to either blocks 410 or 412, the method 400 then moves to block 414 and ends.

Referring to FIG. 4 a method 500 for converting check information 222 into debit card data 250 is shown. The method 500 is initiated at block 501 when check information 222 is retrieved by the check reader 210 and transmitted to conversion device 240. Then, at block 502, the conversion device 240 receives check information 222 from the check reader 210. At block 504, the check information 222 is converted to debit card data 250 by formatting the check information 222 as debit card data 250 for transmission over a debit card network 282. Moving to block 506, the conversion device 240 then transmits the debit card data 250 to demand account 272 within financial institution 270. Then the method 500 moves to block 508 and ends.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computers), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.)

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Those skilled in the art will recognize that it is common within the art to implement devices and/or processes and/or systems in the fashion(s) set forth herein, and thereafter use engineering and/or business practices to integrate such implemented devices and/or processes and/or systems into more comprehensive devices and/or processes and/or systems. That is, at least a portion of the devices and/or processes and/or systems described herein can be integrated into comprehensive devices and/or processes and/or systems via a reasonable amount of experimentation. Those having skill in the art will recognize that examples of such comprehensive devices and/or processes and/or systems might include—as appropriate to context and application—all or part of devices and/or processes and/or systems of (a) an air conveyance (e.g., an airplane, rocket, hovercraft, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Quest, Southwestern Bell, etc.); or (g) a wired/wireless services entity such as Sprint, Cingular, Nextel, etc.), etc.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. Accordingly, the invention is not to be restricted except in light of the appended claims and their equivalents.

1. A method for communicating check information to a financial institution, the method comprising:
retrieving check information from a drawn check, wherein the check information includes an amount of money, a routing number, and an account number;
transmitting the check information to a conversion device;
converting the check information into debit card data; and
transmitting the debit card data to a financial institution having a demand account, wherein the financial institution is assigned the routing number of the drawn check, and wherein the demand account is assigned the account number of the drawn check.

2. The method of claim 1 further comprising:
receiving the debit card data at the financial institution; and
issuing money from the demand account equal to the amount of money on the drawn check.

3. The method of claim 1 further comprising debiting the checking account upon receiving the debit card data at the financial institution.

4. The method of claim 3, wherein the debiting of the checking account occurs within one hour of transmitting the debit card data.

5. The method of claim 1, wherein the retrieving of the check information includes optically scanning the drawn check and saving image data which can be used to reproduce an image of drawn check.

6. The method of claim 5, wherein the retrieving of the check information further comprises applying optical character recognition on the image data.

7. The method of claim 1, wherein the debit card data includes the amount of money, the routing number, the account number, and debit card network information.

8. A system for communicating check information to a financial institution, the system comprising:
a check reader which retrieves check information from a drawn check, wherein the check information includes an amount of money, a routing number, and an account number;
a centralized computer in communication with the check reader, wherein the centralized computer converts the check information into debit card data for transmission over a debit card network; and
a financial institution computer in communication with the centralized computer via the debit card network, wherein the debit card data is transmitted to the financial institution over the debit card network.

9. The system of claim 8, wherein upon receipt of the debit card data and upon determination that sufficient funds exist in a demand account assigned the account number on the drawn check, the demand account is debited by the financial institution computer.

10. The system of claim 8, wherein upon receipt of the debit card data and upon determination that sufficient funds do not exist in the demand account, an insufficient funds notice is transmitted back to the centralized computer.

11. The system of claim 8, wherein the insufficient funds notice is communicated to a beneficiary of the check via the centralized computer.

12. The system of claim 8, wherein the check reader includes an imaging device which captures an image of a drawn check and saves the image as image data, and an imaging recognition computer which retrieves the check information from the image data.

13. The system of claim 8, wherein an available balance of the demand account is debited upon receipt of the debit card data by the financial institution computer.

14. The system of claim 8, wherein an available balance of the demand account is debited in the same amount as the amount of money in the check information.

15. The system of claim 14, wherein the available balance is debited within one hour.

16. The system of claim 8, wherein the wherein the centralized computer converts the check information into debit card data by placing the check information in a debit card format so that the debit card data may be transmitted over the debit card network.

17. The system of claim 8, wherein upon debiting the demand account, an amount of money equal to the amount of money in the check information is flagged for withdrawal from the demand account and to a payee's account.

18. A signal bearing medium storing instructions of a computer program which when executed by a computer results in performance of steps comprising:
receiving check information from a drawn check, wherein the check information includes an amount of money, a routing number, and an account number;
converting the check information into debit card data, wherein the debit card data includes the amount of money, the routing number, and the account number, and a debit card network name; and
transmitting the debit card data to a demand account at a financial institution, wherein the financial institution is assigned the routing number of the drawn check, and wherein the demand account is assigned the account number of the drawn check.

19. The signal bearing medium of claim 17, wherein the converting of the check information into debit card data includes formatting the check information as debit card data so that the debit card data may be transmitted over a debit card network.

20. The signal bearing medium of claim 17, wherein the check information and the debit card data both include a check maker's name.

21. The signal bearing medium of claim 17, further comprising transmitting the debit card data to the demand account via a debit card network associated with the debit card network name.
